(19) United States
(12) Patent Application Publication
(10) Pub. No.: US 2007/0178260 A1
(43) Pub. Date: Aug. 2, 2007

(54) Paper having discrete regions of ferromagnetic material and process of making the same

(76) Inventors: Avery Levy, Harrison, NY (US); Zory Ginzburg, New York, NY (US)

Correspondence Address: FULBRIGHT AND JAWORSKI LLP, 555 S. FLOWER STREET, 41ST FLOOR, LOS ANGELES, CA, 90071, US

(21) Appl. No.: 11/341,734

(22) Filed: Jan. 27, 2006

(51) Int. Cl. B32B 27/10; B32B 15/00

(52) U.S. Cl. 428/34.2; 428/692.1; 428/537.5

(57) ABSTRACT

A sheet of paper having ferrogmagnetic material integrally incorporated into discrete portions thereof. The ferromagnetic material may be disposed in specifically selected and measured positions or may be randomly disposed. The paper is formed by providing a plurality of depressions, indentations or cells in a surface thereof. Ferromagnetic particles are deposited on the surface containing the cells, depressions or indentations after which an additional layer of paper is secured to retained the particles in place.

The present invention relates generally to paper making and more specifically to a paper which has contained therein and as an integral part thereof discrete regions of ferromagnetic material which can be utilized to read and write information and to the process for making such a paper.

### BACKGROUND OF THE INVENTION

The art of paper-making is very old and has developed such that there exists high speed machinery used to make paper of all types. Typically such machinery is either a cylinder mould paper-making machine or a Fourdrinier paper-making machine. In each of these machines, there is a wet end and a dry end. In the wet end, the diluted pulp stock comes into contact with a wire or mesh of the paper making machine and is formed into a sheet. In the cylinder mould paper-making machine, the fibers are deposited on a wire mesh to form a sheet which is couched from the cylinder by a couch roll and conveyed away. In the Fourdrinier machine, the diluted stock is poured onto a wire with the fibers distributed evenly over the whole width of the paper making machine and is laterally transported and then removed by a dandy roll.

It is well known in the art that in either instance, the wire may be provided with raised or sunken portions or masks which provide indentations or depressions in the surface of the wet sheet of paper which contacts the masks. The wire formed in this manner provides areas of thickness and density differences generated by the raised or sunken portions of the masks and typically such areas of thickness and density differences are used to provide watermarks or regions where printing is applied in such a manner that a security paper is provided that is difficult to falsify.

It is also known to provide paper which comprises a special magnetic pigment formulation within the body of the sheet of paper. Typically such paper includes two or more layers of paper with special magnetic pigment formulation sandwiched between and co-extensive with the two layers of paper. Such paper can be utilized to receive and to convey magnetically recorded data which may be written onto the special magnetic pigment formulation by utilizing conventional magnetic read and write heads.

Such paper containing the special magnetic pigment formulation may be utilized in areas where it is desired to monitor workflow, track goods or invoices, delivery notes, transportation documents and the like.

The present invention is an improvement over the known security papers and the paper having the special magnetic pigment formulation contained therein. The present invention provides a layer of traditional paper which has discrete regions or portions of ferromagnetic material disposed therein in such a manner that the existence of the discrete regions of ferromagnetic material cannot be discerned by the naked eye. The discrete regions of ferromagnetic material are disposed integrally within the layer of traditional paper and may be utilized for reading or writing information which pertains to the application of the paper to a particular function.

### SUMMARY OF THE INVENTION

The present invention is a paper having at least one discrete portion of ferromagnetic material disposed integrally therein, such ferromagnetic material being disposed within depressions formed within a surface of said paper and having a further layer of paper over at least the depressions carrying the ferromagnetic material. The invention also is a method of making paper having at least one portion of ferromagnetic material integrally formed therein which includes creating a plurality of indentations, depressions or cells in the paper surface, depositing a ferromagnetic material in the indentations, depressions, or cells and securing a further layer of paper over at least the indentations, depressions or cells carrying the ferromagnetic material.

### BRIEF DESCRIPTION OF THE DRAWINGS

FIG. 1 is a schematic representation of a paper-making machine including a section for making the paper of the present invention;

FIG. 2 is a schematic representation in plan view of one embodiment of paper made in accordance with the present invention;

FIG. 3 is a schematic representation in plan view of an alternative embodiment of paper made in accordance with the principles of the present invention;

FIG. 4 is a cross-sectional view of a layer of paper which has formed in a surface thereof depressions made during the paper-making process and more particularly within the wet end of the machinery;

FIG. 5 is a plan view in schematic representation of the depressions formed in the surface of a paper as illustrated in FIG. 4;

FIG. 6 is a cross-sectional schematic representation of the depressions as illustrated in FIG. 4 within which have been deposited particles of ferromagnetic material; and

FIG. 7 is a cross-sectional view taken about the lines 7-7 of FIG. 2 illustrating paper in which the ferromagnetic materials is positioned in a specifically measured and placed portion of the paper.

### DETAILED DESCRIPTION OF THE INVENTION

The utilization of magnetic stripes on various items such as credit cards, tickets, identification cards or the like to store digital information which can be recovered is well known at the present time. In addition, the utilization of security paper upon which there has been provided watermarks of various types is also well known. The development of such products has led to the further development of paper which has a special magnetic pigment formulation sandwiched between and co-extensive with two sheets of paper while the surfaces of the paper are still adapted to utilize traditional printing techniques and, as a result those surfaces may be treated to exhibit gloss, matte, or other functional coatings. The paper containing the special magnetic pigment formulation incorporated within the body thereof is structured so that the entire sheet may be utilized to read, write and store magnetic data in addition to bearing printed information upon the surface thereof. This paper has many applications such as, for example, forms and tickets where it is necessary to store and retrieve data or where reconciliation is required between visually printed information and machine readable information. Such data may widely vary but typically could include information such as serial numbers, personal details, production workflow, invoices, and goods tracking environments such as delivery notes, transport documents, production workflow documents and the like. The present invention is directed to a sheet of paper having discrete portions of ferromagnetic material disposed integrally therein and is also directed to the process of making such a sheet of paper. In this description, the term “paper” indicates any sheet obtained in wet fashion with the aid of a suspension of natural cellulose fibers and/or synthetic fibers which can contain various fillers and various additives currently used in paper-making including mechanical, chemical, or semi-chemical pulp.

The art of paper-making and the machinery used for such paper-making, both cylinder mould paper-making machines and Fourdrinier paper-making machines, are old and well known in the art and thus no detailed description of such machines or the processes for making paper resulting therefrom is required.

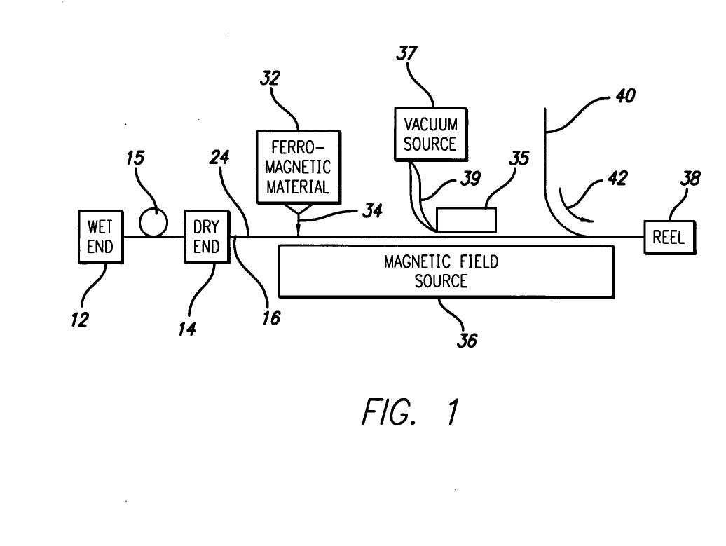

Referring now to the drawings, and more particularly to FIG. 1, there is disclosed in schematic form a paper-making machine. The paper-making machine includes a wet end 12 and a dry end 14. The paper-making machine as shown may be either a cylinder mould paper-making machine or a Fourdrinier paper-making machine as above indicated. In a cylinder mould paper-making machine, paper stock is disposed within a container and the fibers in the paper-making stock deposit on wire mesh to form a sheet which is couched from the cylinder by a couch roll and conveyed away. The sheet is then conveyed to the dry end and from that point to a reel or otherwise to be positioned for a desired application.

In a Fourdrinier paper-making machine, the wet end includes a wire section which is typically a woven plastic mesh conveyor belt upon which the stock diluted with water flows from a flow box which distributes the fibers evenly over the whole width of the wire. As the paper stock flows from the flow box onto the wire, the water drains away from the mesh leaving tiny fibers as a mat on top of the mesh. By the time the stock has traveled halfway down the wire, a high percentage of water has drained away. From this point, the removal of water has to be assisted by suction from underneath the wire. A dandy roll is situated near the end of the wire and is covered with a woven wire which is in contact with the upper surface of the forming sheet and can lift the sheet of fibers from the wire and transport it to the dry end of the paper-making machine. The dry end typically includes a number of drying cylinders as well as press rolls, size presses and the like to dry the resulting paper sheet to the desired water content appropriate for proper handling and conveyance to the reels.

In accordance with the principles of the present invention, when the paper sheet is moving through the wet end or immediately subsequent to the removal therefrom, a plurality of depressions, indentations or cells are formed in predetermined discrete portions of one surface of the paper sheet. As will be described more fully below, the depressions, indentations or cells are formed to have sufficient depth to accept and retain ferromagnetic material therein within the predetermined desired portions of the paper. The depressions, indentations or cells may be any number depending upon the application for which the paper is being manufactured.

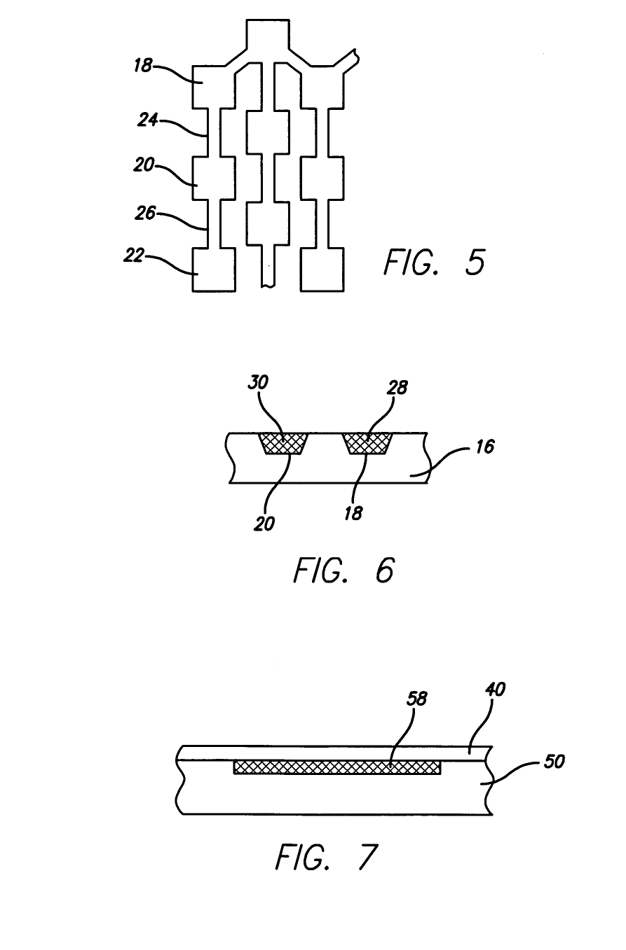

Referring now more particularly to FIGS. 4 through 6, the paper 16 having a plurality of cells 18, 20 and 22 formed in the upper surface 24 thereof is illustrated. The cells 18, 20 and 22 may be interconnected as illustrated at 24 and 26 in FIG. 5. The interconnections may be between adjacent cells or all cells may be interconnected each to the other depending upon the application and the amount of ferromagnetic material to be deposited and utilized in accordance with the principles of the present invention. As shown in FIG. 6, the cells 18 and 20 in the upper surface of the paper 16 are each filled with particles of ferromagnetic material 28 and 30. It should be understood that although only a minor number of cells are illustrated in FIGS. 4, 5 and 6, for purposes of ease of illustration and description, that any number of cells, depressions or indentations may be included in the upper surface 24 of the paper 16.

The cells, indentations or depressions are relatively simple to make and, according to one embodiment of the invention, they are formed by a wire for use during the wet stage of the paper-making with a set of masks suitable for creating the cells, depressions or indentations such as those shown at 18, 20 and 22. These masks by being in contact with a surface of the paper provide the depressions, indentations or cells formed in a thickness of the paper in the predetermined zones or regions where the ferromagnetic material is to be deposited. A more detailed description of a process by which the cells are formed is provided in U.S. Pat. No. 6,911,115 which, by this reference, is incorporated herein for purposes of a full disclosure.

When utilizing a cylinder mould paper-making machine, the depressions are generated in the paper by utilizing a support surface upon which the fibers are continuously deposited to form a paper sheet with a wire mesh having raised portions thereon. The raised portions may however be additions to the support surface such as blocks attached to the wire mesh surface or arches of wire or similar material mounted on the support surface. For a more detailed description and teaching of the formation of such depressions when utilizing a cylinder mould paper-making machine, reference is made to U.S. Pat. No. 4,462,866 which is, by this reference, incorporated herein for a further and full disclosure.

In an alternative embodiment of the present invention, the depressions, indentations or cells may be formed by passing the paper under a roller having a plurality of raised portions thereon. The roller may be located in the wet end or dry end of the paper making machine but preferably is located between the wet and dry ends as shown at 15 in FIG. 1. In this position, the roller contacts the paper surface before the paper is dry and the desired depressions, indentations or cells may be formed. Alternatively, the roller may have a surface which performs a grinding operation to remove small portions of the paper surface to form the depressions, indentations or cells.

Irrespective of how the depressions, indentations or cells are formed, they will have a depth sufficient to receive and retain particles of ferromagnetic material as will be more fully described below.

Referring again to FIG. 1 after the paper 16 leaves the dry end 14 of the paper-making machine, it now has the plurality of cells, depressions or indentations as above described formed in the upper surface 24 thereof. As the upper surface 24 passes beneath a dispenser 32, ferromagnetic material is released therefrom as shown by the arrow 34 and is deposited on the upper surface 24 of the sheet of paper. The ferromagnetic material may be in particle form. The ferromagnetic material is held in position on the upper surface 24 of the paper 16 by application of a magnetic field from a magnetic field source 36 which applies an attractive force to the particles of magnetic material causing them to move into and fill the cells as shown at 18, 20 and 22. The magnetic field source may be a permanent magnet or an electromagnet as well known. As the paper 16 continues to move toward the reel 38 an additional layer of paper 40 moves downwardly as shown by the arrow 42 and is attached to the upper surface 24 of the paper layer 16. The additional layer 40 of paper is attached while the magnetic field is still effective and thus serves to cover and retain the particles of ferromagnetic material in place on the upper surface 24 of the paper layer 16. After application of the layer 40 of material, the resulting composite paper layer is transmitted to a reel 38 where it is stored, as is well known in the paper-making art.

Although it is illustrated schematically in FIG. 1 that the ferromagnetic material is applied to the paper which exits the dry end 14 of the paper-making machine immediately after such exit, it should be understood that the paper containing the plurality of cells, depressions or indentations may be transported directly to the reel 38 and subsequently transported to an additional station where the paper is removed from the reel and passed through an additional station where the ferromagnetic material is applied and the sheet 40 of paper applied over the upper surface of the sheet 16.

Particles of the ferromagnetic material may be deposited on the upper surface 24 of the paper 16 outside the depressions, indentations or cells. These particles should be removed before the additional layer 40 of paper is applied. The removal may be accomplished in any manner known to the art and may, for example, be accomplished by using a doctor blade 35 along with a vacuum source 35. The doctor blade dislodges the ferromagnetic particles not contained within the depressions, indentations or cells, even though the magnetic field is present, and the vacuum picks up the dislodged particles and transports them through the conduit 39 to a receiving area (not shown).

Alternatively to utilizing the magnetic field source, the ferromagnetic material may be mixed with an appropriate binder after which it is applied to the upper surface 24 to fill the plurality of depressions, indentations or cells appearing thereon. When a binder is used, an appropriate curing station is required to cure the binder and cause the ferromagnetic material to be secured within the cells appearing on the upper surface 24 of the layer of paper 16. Subsequently, the additional layer 40 of paper is applied there over as above described. Although alternative ways of applying the ferromagnetic material to the paper surface are disclosed, it is intended to include any other method known to the art for impregnating the paper with the ferromagnetic material.

The ferromagnetic material may be any material capable of functioning as a magnetic recording medium, such as a ferromagnetic metal powder, and may contain, if desired, additional elements which will render the material more stable and capable of receiving and maintaining analog or digitally recorded information. The ferromagnetic metal powder may, for example, contain particles of cobalt, aluminum, and yttrium. Examples of a binder which may be used under these circumstances is a polyurethane resin, an acrylic resin, a cellulose resin or a vinylchloride resin.

By reference now more particularly to FIG. 2, there is illustrated in schematic fashion a plan view of a sheet of paper 50 having a plurality of rows 52, 54, 56 and 58 of magnetic recording medium integrated therein in the manner as above described. The rows 52-58 may be continuous or may be broken into sections. It will be recognized by those skilled in the art that each of the rows of magnetic recording medium may have any desired width depending upon the amount of data to be recorded therein. The rows of magnetic recording medium as shown in FIG. 2 are specifically measured and placed in predetermined positions within the layer 50 of paper depending upon the particular application for which the paper is intended. These rows may be placed at any desired position in the paper but that position is previously determined, measured and specifically placed.

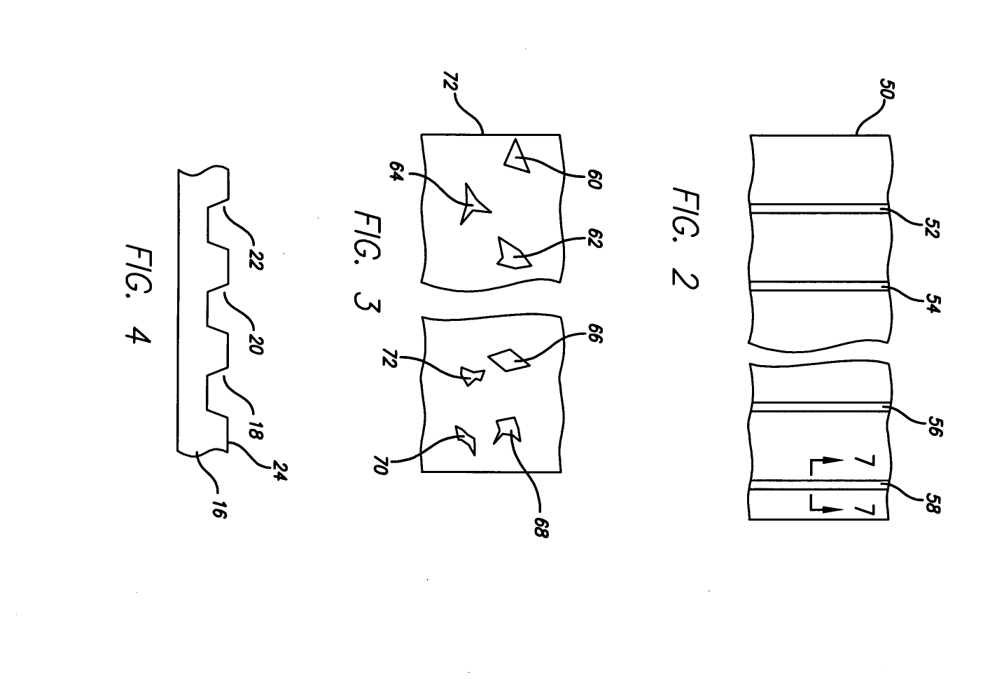

Alternatively, the magnetic recording medium may be disposed and contained within randomly disposed portions as shown at 60 through 70 in FIG. 3 on the sheet of paper 72. Each of the randomly disposed portions 60 through 70 contain a plurality of discrete cells, depressions or indentations which are formed in the manner above described utilizing a wire having a plurality of masks thereon or a roller with raised portions thereon. It will be recognized that since the wire having the masks or the roller to form the randomly disposed portions is placed on the paper-making machine, that even though these appear to be randomly disposed portions when the surface of the paper is viewed, that the randomly disposed portions will be repeated as the wire rotates. Thus, the term “randomly disposed” is to be distinguished from the continuous strip of magnetic recording medium as shown in FIG. 2.

Referring now more particularly to FIG. 7 there is illustrated the layer of paper 50 shown in FIG. 2 having the magnetic recording medium 58 contained therein which is covered by the additional sheet 40 of paper. It will be recognized that the row of magnetic recording medium is contained integrally within the layer 50 of paper by depositing the same within and substantially filling the cells, depressions or indentations and the interconnections therebetween formed as illustrated at 18, 20 and 22 and above described.

When the paper as described above is formed, it is later slit or cut into desired sizes from the final reel thereof for utilization in a desired application. The paper which is constructed in accordance with the present invention may be utilized for any application desired such as stationery, envelopes, tickets, forms, accounting paper, invoices and the like wherever it is desired to print upon the outer surface of the paper and, at the same time, to utilize magnetic read/write heads to record and read information in analog or digital format on the digital recording medium. It should be clear, particularly by reference to FIG. 7, that the existence of the row of magnetic recording medium 58 would not be discernible to the naked eye because it is covered by the layer of paper 40. This then provides additional security to any document utilizing the portion of ferromagnetic material formed integrally in the paper as described herein.

There has thus been described a paper containing at least one discrete portion of ferromagnetic material therein to provide a magnetic recording medium integrated within the paper and a method of making such paper.

What is claimed is:

1. A method of making paper having at least one portion of ferromagnetic material formed integrally therein comprising:
providing a sheet of paper;
forming a plurality of depressions, indentations or cells in a first surface of said sheet of paper;
depositing a ferromagnetic material in said plurality of depressions, indentations or cells; and
securing a further layer of paper over at least the depressions, indentations or cells carrying the ferromagnetic material.

2. The method as defined in claim 1 wherein said forming step includes a wire having masks in a Fourdrinier paper making machine.

3. The method as defined in claim 1 wherein said forming step includes a wire mesh having raised portions in a cylinder mold paper making machine.

4. The method as defined in claim 1 wherein said forming step includes a roller having raised portions contacting said first surface of said sheet of paper.

5. The method of claim 1 wherein said forming step includes a roller having a surface for grinding to remove portions of said first surface of said sheet of paper.

6. A method of making paper having at least one portion of ferromagnetic material therein comprising:
providing a wire carrying a mask;
positioning the mask at a predetermined point in the wet stage of paper making for creating depressions, indentations or cells in the paper that contacts the masks;
depositing a ferromagnetic material in said depressions, indentations or cells; and
securing a further layer of paper over at least the depressions, indentations or cells carrying the ferromagnetic material.

7. The method of claim 6 wherein the mask is positioned to provide the depressions, indentations or cells at a specifically measured and placed position on the paper.

8. The method of claim 6 wherein the mask is a plurality of masks positioned on the wire to provide randomly placed discrete sets of depressions, indentations or cells.

9. The method of claim 6 which further includes securing said ferromagnetic material within said depressions, indentations or cells with a magnetic field until said further layer of paper is secured.

10. The method of claim 6 wherein said ferromagnetic material is contained in a binder.

11. The method of claim 10 which includes curing said binder.

12. The method of claim 9 wherein said ferromagnetic material is deposited on one surface of said paper and said magnetic field is applied to the opposite surface of said paper.

13. The method of claim 12 wherein said magnetic field is maintained until said further layer of paper is secured over said depressions, indentations or cells containing said ferromagnetic material.

14. A method of making paper having at least one portion of ferromagnetic material therein comprising:
providing a roller having raised portions;
positioning the roller at a predetermined point for contacting a surface of the paper sheet for creating depressions, indentations or cells therein;
depositing a ferromagnetic material in said depressions, indentations or cells; and
securing a further layer of paper over at least the depressions, indentations, or cells carrying the ferromagnetic material.

15. The method of claim 14 wherein the roller is positioned to provide the depressions, indentations or cells at a specifically measured and placed position on the paper.

16. The method of claim 14 wherein the roller is a plurality of masks positioned on the wire to provide randomly placed discrete sets of depressions, indentations or cells.

17. The method of claim 14 which further includes securing said ferromagnetic material within said depressions, indentations or cells with a magnetic field until said further layer of paper is secured.

18. The method of claim 14 wherein said ferromagnetic material is contained in a binder.

19. The method of claim 18 which includes curing said binder.

20. The method of claim 17 wherein said ferromagnetic material is deposited on one surface of said paper and said magnetic field is applied to the opposite surface of said paper.

21. The method of claim 20 wherein said magnetic field is maintained until said further layer of paper is secured over said depressions, indentations or cells containing said ferromagnetic material.

22. A method of making paper having at least one portion of ferromagnetic material therein comprising:
providing a roller having raised portions;
positioning said roller at a predetermined point for grinding a surface of the paper sheet to create a plurality of depressions, indentations, or cells therein;
depositing a ferromagnetic material in said depressions, indentations or cells; and
securing a further layer of paper over at least the depressions, indentations, or cells carrying the ferromagnetic material.

23. The method of claim 22 wherein the roller is positioned to provide the depressions, indentations or cells at a specifically measured and placed position on the paper.

24. The method of claim 22 wherein the roller is a plurality of masks positioned on the wire to provide randomly placed discrete sets of depressions, indentations or cells.

25. The method of claim 22 which further includes securing said ferromagnetic material within said depressions, indentations or cells with a magnetic field until said further layer of paper is secured.

26. The method of claim 22 wherein said ferromagnetic material is contained in a binder.

27. The method of claim 26 which includes curing said binder.

28. The method of claim 25 wherein said ferromagnetic material is deposited on one surface of said paper and said magnetic field is applied to the opposite surface of said paper.

29. The method of claim 28 wherein said magnetic field is maintained until said further layer of paper is secured over said depressions, indentations or cells containing said ferromagnetic material.

30. A sheet of paper having a magnetic recording medium integrally incorporated in at least a portion thereof comprising:
a plurality of depressions formed within a portion of one surface thereof;
ferromagnetic particles disposed within said depressions; and
a further layer of paper disposed over said plurality of depressions.

31. A sheet of paper as defined in claim 30 wherein said plurality of depressions, indentations or cells are disposed in at least one predetermined measured position.

32. A sheet of paper as defined in claim 30 wherein said plurality of depressions, indentations or cells are randomly disposed.

33. A sheet of paper as defined in claim 31 wherein as plurality of depressions, indentations or cells are interconnected and are substantially filled with said ferromagnetic particles.

34. A sheet of paper as defined in claim 32 wherein as plurality of depressions, indentations or cells are interconnected and are substantially filled with said ferromagnetic particles.

35. A sheet of paper as defined in claim 30 wherein said further layer of paper is the only means for retaining said ferromagnetic particles within said depressions, indentations or cells.

36. A sheet of paper as defined in claim 30 wherein said ferromagnetic particles are mixed with a binder.
